(19) United States
(12) Patent Application Publication
(10) Pub. No.: US 2011/0311172 A1
(43) Pub. Date: Dec. 22, 2011

(54) COMPONENT AND METHOD FOR THE PRODUCTION THEREOF

(76) Inventor: Egon Frank, Theres (DE)

(21) Appl. No.: 13/203,783

(22) PCT Filed: Feb. 24, 2010
(86) PCT No.: PCT/EP2010/001127

§ 371 Date: Aug. 29, 2011

(30) Foreign Application Priority Data
Mar. 6, 2009 (DE) 10 2009 011 585.4

(51) Int. Cl. F16C 19/00; B32B 37/16

(52) U.S. Cl. 384/445; 156/172

(57) ABSTRACT

The invention relates to a component (1) with an axis (A) consisting of at least a first layer (2) in the form of a tubular body and at least a second layer (3) which is arranged outside and/or inside of the tubular body (2) and which is firmly connected with the first layer (2). To make the element lightly and abrasive resistant simultaneously, the first layer (2) consists of a composite material, wherein the second layer (3) consists of a hard material. Furthermore, the invention relates to a method for the production of such an element.

The invention relates to a component with an axis consisting of at least two layers. Furthermore, the invention relates to a method for the production of such a component.

Components are required in a lot of applications which must have a high stability and a low weight. Under the aspect of a low weight plastic material as the material of the element can be considered. In most cases this does not have the necessary stability. Hence, it is known to incorporate reinforcement fibres into the plastic material to increase the stability of the material. Especially, the use of glass fibres and carbon fibres is known. Also, a technology is known in which long reinforcing fibres are wrapped around an element base body during rotation of the base body. Thereby, components with a high stability can be produced.

However, it is detrimental that also stiff and firm components of the mentioned kind often do not have the stability on its surface to be subjected over long operation times with high loads without abrasion.

Different composite elements and method for their production are disclosed in the prior art. DE 10 2008 013 203 A1 discloses a cantilever beam which comprises a metallic hollow profile, which is equipped with a reinforcing layer from a fibre plastic composite. DE 94 21 315 U1 shows a composite body with different layers. In DE 37 15 894 A1 a fibre arrangement being coated with synthetic resin is wrapped around a mandrel and the wrapped body including the mandrel is inserted into a thin-walled metal tube. Wrapping of a roller body with carbon yarn is proposed in DE 35 27 912 A1, wherein a layer is applied onto the shell of the roller body by plasma spraying. Similar as well as other solutions are described in DE 84 06 019 U1, in DE 195 08 193 A1, in DE 195 09 585 A1, in CH 688 943 A5, in DE 42 26 789 A1, in DE 600 14 787 T2 and in U.S. Pat. No 5,334,124.

Thus, it is an object of the invention to further develop a component of the mentioned kind and to propose an economical method for its production so that it becomes possible to use the component under high load and nevertheless to ensure a low relative density of the component.

The solution of this object by the invention is characterized in that the component has an axis and consists of at least a first layer in the form of a tubular body and at least a second layer which is arranged outside and/or inside of the tubular body and which is firmly connected with the first layer, wherein the first layer consists of a composite material, wherein the second layer consists of a hard material, wherein the first layer of composite material comprises a plastic material in the form of a thermosetting material as a base material in which plastic material at least one reinforcing element is incorporated, wherein the at least one reinforcing element is a long glass fibre, carbon fibre, or aramid fibre by which a plastic base body is wrapped, and wherein the second layer consists of a hard material in the form of ceramics or of a hard material in the form of a thermosetting hard system, in which metal powder and/or ceramic powder is incorporated in a thermosetting matrix, or of a hard material in the form of a metal.

The component has preferably a hollow cylindrical shape.

The second layer can be deposited on the First layer by means of a plasma coating process. It can also be arranged as a separately produced element onto the first layer. In this case a preferred solution proposes that the second layer is produced from a strip which is bent and deposited on the first layer.

A variation proposes that the first layer and/or the second layer consists of foamed material or comprises at least partially such a material.

The preferred embodiment of the component provides that the first layer is arranged radial inwardly and the second layer is arranged radial outwardly. According to a preferred application the component is a rolling element or a bearing ring of a roller bearing.

A specific embodiment of the invention provides that at least one ancillary component is integrated into the first layer. For example, the ancillary component can be sensor element (with active or passive function) or a strain gauge.

The method according to the invention for the production of a component with an axis consisting of at least a first layer in the form of a tubular body and at least a second layer which is arranged outside and/or inside of the tubular body and which is firmly connected with the first layer proposes the method steps—preferably in this order:
a) Production of the tubular body from a thermosetting base material, wherein on the base material at least one long glass fibre, carbon fibre, or aramid fibre is wrapped by rotation of the body around the axis;
b) Applying of the second layer from a hard material onto the inner and/or outer surface of the tubular body of the first layer, wherein the hard material is ceramic material or a thermosetting hard system, in which metal powder and/or ceramic powder is incorporated in a thermosetting matrix, or metal.

A preferred deposition of the second layer takes place by means of a plasma coating process.

An advantageous embodiment of the proposed method provides that the second layer is subjected to a pyrolytic process to subject it at least partially to a transformation for increasing its temperature stability. By a subsequent pyrolytic transformation process it is especially possible to give a fibre composition material physical properties which allow to obtain a very high temperature stability in the hybrid material.

As mentioned a preferred application of the proposed component is the field of roller bearings and here especially the use as a rolling element, for example as a cylindrical roller or taper roller, or as a bearing inner ring or hearing outer ring (as well for sliding bearings and for roller bearings). The surface of the component is abrasive resistant due to the use of the hard material, the weight and especially the relative density of the component is relatively low.

If the component is used as a bearing ring the (weight) advantages are specifically high if the element is a large size bearing.

The proposed fibre composition component (first layer) is thus provided with an abrasive protection in the form of a second layer from hard material. Instead of the density of steel (7.28 kg/dm³) a value for the density between 1.3 and 2.1 kg/dm³ can be obtained with quite comparable stability. So, the weight of the component becomes not only lower, also the mass moments of inertia become small respectively. Thus, a saving of weight up to 80% of the weight of a component is possible which is produced in a classical way.

The degree of efficiency of a technical device can be improved by this manner where applicable. Also, energy can be saved during the production with the proposal according to the invention in relation to the pre-known manufacturing methods.

Furthermore it is beneficial that during the application of the second layer from hard material, e. g. by thermal plasma spraying, an accuracy in shape can be obtained which can lie in the region of the accuracy of a grinding operation.

By the proposal according to the invention the component can be produced in a very economical manner, especially in the case of a rolling element of a roller bearing or a bearing inner ring or bearing outer ring, but also in the case of a roller bearing cage. Here, the cost effectiveness of the invention proposal is especially high in the case of large size bearing.

The component is corrosion resistant and resistant against chemical influences (acids). In dependence from the used materials for the first and/or second layer the component can be made either electrically isolating or electrical conducting as the case may by which functionality is aimed for respectively.

The selection of the material for the two layers determines also further physical properties of the component, like for example the thermal expansion. Also, the behaviour of the conduction of heat can thus be influenced respectively. This can be used for the optimization of the life time specifically in the application in the field of bearings. Here, especially emergency operation properties can be improved, for example in the case of damages of the bearing.

The hybrid design of the component by the connection of the two layers is beneficial, which layers can have respective different physical properties. This applies also for example for the damping behavior of the component. If the layers are selected respectively a high damping ability can be obtained.

It is also beneficially that the absorbable contact pressure per unit area reaches a level which corresponds to that one of a conventional material (light metal, nonferrous metals or steel alloys).

Thus, the proposal according to the invention is directed to the production of fibre composite parts with regard to the fact that the surface properties are improved by means of the proposed measures (especially the compressive strength, the abrasive resistances and the tribological properties). So, the advantages of conventional materials can be combined with the advantages of new materials, which are lighter and can have anisotropic properties.

Especially supporting rings, outer rings and inner rings of roller bearings and slide bearings, cages of roller hearings, hollow shafts (tubes, rollers etc.) can be produced economically and individually.

In the drawing an embodiment of the invention is shown.

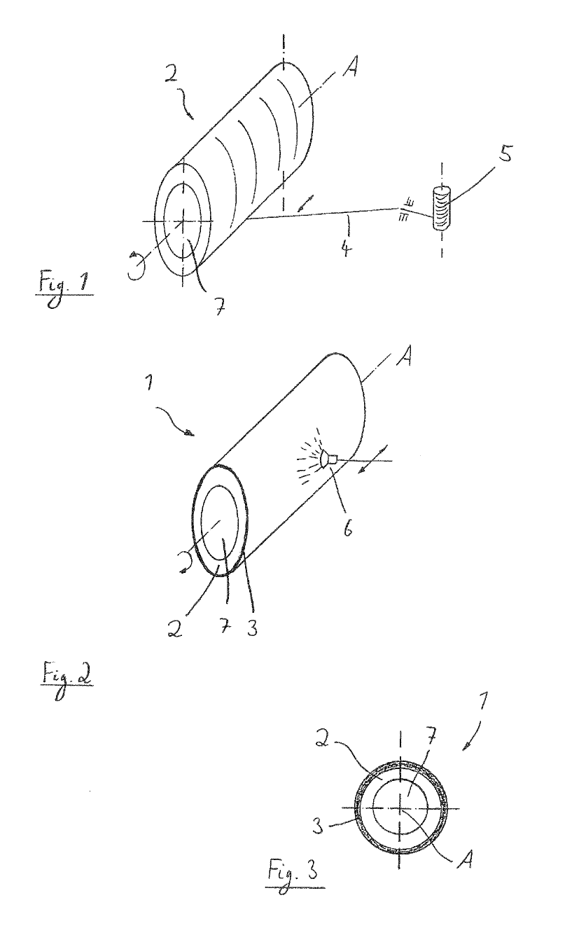

FIG. 1 shows schematically a tubular body during its production,

FIG. 2 shows schematically the application of a hard material layer onto the tubular body and

FIG. 3 shows—seen in axial direction—the produced component consisting of a first and a second layer.

In FIG. 1 it is shown how a tubular body—here in the form of a hollow cylinder—is produced, which forms the first layer 2 of a component 1 (see FIG. 3) which has to be produced. The tubular body has a plastic material matrix from a thermoplastic or thermosetting material in which a reinforcing element in the form of a reinforcing fibre 4 made of glass or carbon is incorporated. For doing so a bobbin 5 is arranged on which the long reinforcing fibre 4 is wound up. The tubular body is rotating around its axis A. During the rotation the reinforcing fibre 4 is spooled onto the circumference of the tubular body which is denoted by the double arrow in FIG. 1.

So, the tubular body, i. e. the first layer gets an anisotropic property, i. e. the stability in the circumferential direction of the body is higher than in longitudinal direction. However, just in circumferential direction mostly higher forces must be carried when the component is used in a rotating manner.

When the first layer 2 is produced the application of a second layer 3 in the form of a hard material takes place according to FIG. 2. In FIG. 2 it is denoted that the hard material is applied onto the pre-produced tubular body by means of plasma spraying; for doing so the spray nozzle 6 is shown exemplary.

As hard materials all materials come into question which have a high surface hardness and abrasive resistance.

For the improvement of the adherence of the second layer 3 on the first layer 2 a suitable bonding agent can be used which is known as such.

The finished component 1 is shown in FIG. 3. The two layers 2 and 3 are arranged coaxially to another. The component 1 has a cavity 7 in its inner which makes it light weighted correspondingly. Nevertheless, the component 1 has a very high stability by means of the wrapped reinforcing fibres which can be completely covered by the plastic material of the basis. The outer layer 3 makes is abrasive resistant and thus long lasting.

As the case may be during the production especially of the first layer 2 additional parts can be integrated into the layer which parts are required for the later operation of the component. But this is not depicted.

With respect to the fibres which are used it should be mentioned that beside the mentioned kinds of fibres also such fibres can be used which are made of metal, especially of steel, or long fibre materials.

### LIST OF REFERENCE NUMERALS

1 Component
2 First layer
3 Second layer
4 Reinforcing fibre
5 Bobbin
6 Spray nozzle
7 Cavity
A Axis

1-16. (canceled)

17. Bearing ring of a bearing, rolling element of a roller bearing or cage of a roller bearing with an axis consisting of at least a first layer in the form of a tubular body and at least a second layer which is arranged outside and/or inside of the tubular body and which is finely connected with the first layer,
wherein the first layer consists of a composite material,
wherein the second layer consists of a hard material,
wherein the first layer (2) of composite material comprises a plastic material in the form of a thermosetting material as a base material in which plastic material at least one reinforcing element is incorporated,
wherein the at least one reinforcing element is a long glass fibre, carbon fibre, or aramid fibre by which a plastic base body is wrapped, and
wherein the second layer (3) consists of a hard material in the form of ceramics or of a hard material in the form of a thermosetting hard system, in which metal powder and/or ceramic powder is incorporated in a thermosetting matrix, or of a hard material in the form of a metal.

18. Bearing ring of a bearing, rolling element of a roller bearing or cage of a roller bearing according to claim 17, characterized in that it has a hollow cylindrical shape.

19. Bearing ring of a bearing, rolling element of a roller bearing or cage of a roller bearing according to claim 17, wherein the second layer is deposited on the first layer by means of a plasma coating process.

20. Bearing ring of a bearing, rolling element of a roller bearing or cage of a roller bearing according to claim 17, wherein the second layer is a separately produced element which is arranged on the first layer.

21. Bearing ring of a bearing, rolling element of a roller bearing or cage of a roller bearing according to claim 20, wherein the second layer is produced from a strip which is bent and deposited on the first layer.

22. Bearing ring of a bearing, rolling element of a roller bearing or cage of a roller bearing according to claim 17, wherein the first layer and/or the second layer consists of foamed material or comprises at least partially such a material.

23. Bearing ring of a bearing, rolling element of a roller bearing or cage of a roller bearing according to claim 17, wherein the first layer is arranged radial inwardly and the second layer is arranged radial outwardly.

24. Bearing ring of a bearing, rolling element of a roller bearing or cage of a roller hearing according to claim 17, wherein at least one ancillary component is integrated into the first layer.

25. Bearing ring of a bearing, rolling element of a roller bearing or cage of a roller bearing according to claim 24, wherein the ancillary component is a sensor element.

26. Bearing ring of a bearing, rolling element of a roller bearing or cage of a roller bearing according to claim 24, wherein the ancillary component is a strain gauge.

27. Method for the production of a bearing ring of a bearing, rolling element of a roller bearing or cage of a roller bearing with an axis consisting of at least a first layer in the form of a tubular body and at least a second layer which is arranged outside and/or inside of the tubular body and which is firmly connected with the first layer,
wherein
the method comprises the steps of:
a) producing a tubular body from a thermosetting base material, wherein on the base material at least one long glass fibre, carbon fibre, or aramid fibre is wrapped by rotation of the body around the axis;
b) applying a second layer from a hard material onto the inner and/or outer surface of the tubular body of the first layer, wherein the hard material is ceramic material or a thermosetting hard system, in which metal powder and/or ceramic powder is incorporated in a thermosetting matrix, or metal.

28. Method according to claim 27, wherein the second layer is applied onto the first layer by means of a plasma coating process.

29. Method according to claim 27, wherein the second layer is at first produced as a separate element and is then deposited onto the first layer.

30. Method according to claim 29, wherein the second layer is at first produced from a strip which is bent and then deposited on the first layer.

31. Method according to claim 27, wherein the second layer is subjected to a pyrolytic process to subject it at least partially to a transformation for increasing its temperature stability.
